(19) United States
(12) Patent Application Publication
(10) Pub. No.: US 2018/0281603 A1
(43) Pub. Date: Oct. 4, 2018

(54) METHOD FOR OPERATING A MOTOR VEHICLE, CONTROL UNIT AND MOTOR VEHICLE

(71) Applicant: Robert Bosch GmbH, Stuttgart (DE)

(72) Inventor: Martin Nordmann, Oberstenfeld-Gronau (DE)

(21) Appl. No.: 15/941,418

(22) Filed: Mar. 30, 2018

(30) Foreign Application Priority Data
Mar. 31, 2017 (DE) 102017205473.5

(51) Int. Cl. B60L 3/10; B60K 7/00

(52) U.S. Cl. CPC B60L 3/102; B60L 3/106; B60K 7/0007; B60L 2240/12; B60L 2240/24; B60L 2240/421; B60L 2240/14; B60L 2240/423; B60L 2240/461; B60L 2240/463; B60L 2240/22

(57) ABSTRACT

A method for operating a motor vehicle, which includes driven wheels and driving machines, each driven wheel being assigned a driving machine, respectively, the method including determining a setpoint total drive torque; measuring a current vehicle traveling speed, a current steering angle and, optionally, the wheel loads of all of the driven wheels; determining individual wheel speeds of motion of the driven wheels over the roadway as a function of the current vehicle traveling speed, the current steering angle, a chassis geometry of the motor vehicle and, optionally, the wheel loads; determining a setpoint rotational speed for each driven wheel as a function of the determined speeds of motion, and distributing the setpoint total drive torque to all driven wheels so that spinning of the specific driven wheel on the roadway is prevented; and controlling each driving machine to set the setpoint rotational speed at the specific driven wheel.

### CROSS REFERENCE

The present application claims the benefit under 35 U.S.C. § 119 of German Patent Application No. DE 102017205473.5 filed on Mar. 31, 2017, which is expressly incorporated herein by reference in its entirety.

The present invention relates to a method for operating a motor vehicle, which includes a plurality of driven wheels and a plurality of driving machines, each driven wheel being assigned a driving machine, in particular, an electrical machine.

In addition, the present invention relates to a control unit for operating a motor vehicle, as well as to a motor vehicle and such a control unit, the control unit implementing the above-mentioned method.

### BACKGROUND INFORMATION

With the increasing electrification of motor vehicles, the electrification of the power train also increases. Besides an internal combustion engine, one or more electrical machines may additionally be provided as driving machines. As an alternative to the internal combustion engine, one or more electrical machines may be provided. In addition, designs that include individual-wheel drive of the motor vehicle are increasingly being developed. To that end, each driven wheel of the motor vehicle is assigned an electrical machine, which may be controlled individually in order to generate a drive torque of the motor vehicle. The driving machines in a motor vehicle are normally modeled by a “torque path” in a control unit, by which a torque inputted by the driver is converted into a setpoint overall drive torque. This setpoint overall drive torque or drive torque is outputted to the driving machine(s) for their control. However, if the driver input is greater than the motive force transmittable to the ground or the roadway, then one or more of the driven wheels of the motor vehicle may spin and lose adhesion to the roadway. If the motor vehicle has a driver assistance system, such as an electronic stability program or a traction control system, then, by this reaction, the spinning wheel may be braked, and the torque may be transmitted to another wheel for driving the motor vehicle. This is accomplished, for example, electrohydraulically/mechanically by the friction brake of the respective wheel, or electronically by driving machines controllable with respect to individual wheels. In this manner, the propulsion of the motor vehicle is maintained in spite of a spinning, driven wheel. Such a loss of traction may occur primarily in response to uneven ground and subsurfaces having different coefficients of friction, and may result in damage to sensitive ground surfaces.

### SUMMARY

An example method in accordance with the present invention may have the advantage that through the individual-wheel electric drive, the driven wheels may be controlled rapidly and selectively (proactively), and in this manner, spinning of one of the driven wheels may be reliably prevented. To this end, the present invention provides that a setpoint total drive torque, that is, a drive torque desired by the driver, be initially determined. In addition, a current traveling speed, optionally, the wheel loads of all driven wheels, and a current steering angle of the motor vehicle are ascertained. Then, individual wheel speeds of motion of the driven wheels over the roadway are determined as a function of the vehicle speed, the current steering angle and the chassis geometry of the motor vehicle. Consequently, in view of the chassis geometry and the behavior of the chassis as a function of a steering angle and, in particular, the wheel loads, an individual wheel speed of motion of each wheel may be ascertained. As a function of the determined speeds of motion and the setpoint total drive torque, a setpoint rotational speed for each driven wheel and a distribution of the setpoint total drive torque to the individual wheels are determined in such a manner, that spinning of the specific traction-drive wheel on the roadway is prevented; each driving machine being controlled in order to set this setpoint rotational speed at the respective driven wheel. Thus, automatic speed control of the driving machine takes place, which is accomplished as a function of the vehicle traveling speed, as well as of the chassis geometry, optionally, the wheel loads, and the current steering angle; which means that the spinning of one of the driven wheels is reliably prevented. This ensures rapid intervention in the operating behavior of the motor vehicle in a simple manner, in order to prevent unsafe driving conditions and damage to the road-surface covering. The wheel loads of the driven wheels, that is, of the wheels of the motor vehicle, are preferably determined as a function of a spring travel and/or tire pressure of an individual wheel. For example, the tire pressure may be measured by tire pressure sensors already present, and the spring travel may be measured by a spring travel sensor system already known, as well. In view of the wheel loads, it may be determined, if one of the driven wheels is suspended in the air and consequently cannot transmit any motive force or braking force to the roadway, or if it is deflected and thereby able to transmit higher torques. This may also be determined dynamically between wheels on the inside and outside of a curve. The effective curve radius of the specific driven wheel also changes with the spring travel actually occurring, which means that with knowledge of the above-mentioned parameters, the method may be implemented particularly accurately.

According to one preferred further refinement of the present invention, it is provided that a combined speed be determined from the speeds of motion of the driven wheels of a common wheel axle. Due to the known chassis and steering geometry, the combined speeds of the wheel axles are known and may be synchronized, so that, for example, a front and rear wheel axle may be synchronized, which constitutes the function of a center differential lock when traveling straight ahead. During cornering, this electronic coupling or synchronization of the front wheel axle and rear wheel axle has the advantage that the compensation for the different path lengths of the front and rear wheel axles by adjustment of the rotational speeds prevents the otherwise forcibly occurring slip at at least one wheel. This basically corresponds to a simplified variant, in which, in each instance, a driving machine is provided for each wheel axle, which means that the wheel axles are synchronized, using combined speeds of the wheel axles, including cornering compensation. If drive machines are provided individually for the wheels, then, on the basis of the known chassis geometry, all of the driven wheels are positively coupled with each other in a manner that compensates for cornering, which corresponds to longitudinal and lateral locking of mechanical differential gears while traveling straight ahead.

In addition, it is preferably provided that as a function of ascertained, combined speeds of a plurality of wheel axles, these wheel axles be synchronized, in particular, with regard to their rotational speed. The advantage mentioned above may be achieved in this manner.

Furthermore, it is preferably provided that the vehicle speed be additionally ascertained, in particular, as a function of at least one actual rotational speed, an acceleration, a yaw rate, data of a satellite-assisted navigation system and/or of a surround sensor system of the motor vehicle. It is particularly advantageous to measure the vehicle speed in a manner removed from the rotational speeds of the driven wheels, so as to be able to have an independently ascertained vehicle speed as a comparison to the automatic speed control of the driven wheels, in order to be able to detect slip over all of the wheels. In this manner, instances of faulty control and swerving of the vehicle are prevented. The acceleration and/or yaw rate of the motor vehicle may also be used for determining the vehicle speed.

The method is preferably executed only at speeds below a specifiable limiting value. In the case of conventional motor vehicles, in which a central driving machine distributes the motive force to a plurality of driven wheels with the aid of a transmission, a spinning, driven wheel, diminishes the vehicle dynamics, which means that, for example, the motor vehicle slows down or stops (e.g., when driving on a mountain), and the driving condition of the motor vehicle remains stable. In the case of individual-wheel drive having automatic speed control, exceedance of the adhesion limit of the driven wheels may result in all of the wheels being able to spin simultaneously and the motor vehicle consequently being able to become unstable. Since traveling is only carried out at speeds below the specifiable limiting value, the effects of an unstable driving condition are simpler to correct. The limiting value is accordingly selected to be safe and ascertained, for example, with the aid of trials. In addition, this loss of adhesion is detected, in particular, with the aid of the vehicle traveling speed ascertained independently of the rotational speeds, and/or with the aid of the ascertained acceleration and/or yaw rate.

Furthermore, it is preferably provided that a current roadway composition be ascertained and the method be executed as a function of the current roadway composition. In particular, power output is limited (automatically or manually) as a function of the current roadway composition, in order to prevent a loss of adhesion, that is, the spinning of all of the driven wheels. The roadway composition may be determined, for example, using the data of the satellite-aided navigation system, and/or with the aid of a camera-based surround sensor system having image analysis.

In addition, it is preferable for the setpoint rotational speeds to be controlled. This allows the method to be maintained easily. However, since, in a controlled system, the accuracy of the control is a function of the measured parameters, and these are limited due to the desired simplicity of the system, then, for example, without speed determination independent of the vehicle and without determination of wheel loads, the controlled operation is preferably implemented only on sensitive roadways, on which the spinning of the driven wheels is supposed to be prevented, and/or only at low speeds, in particular, less than the above-mentioned limiting value. Alternatively, the setpoint rotational speeds are regulated, as already described above.

An example control unit in accordance with the present invention is specially configured to execute the example method of the present invention when used as intended. In this context, the advantages mentioned above apply to the motor vehicle.

An example motor vehicle in accordance with the present invention includes the example control unit of the present invention. The above-mentioned advantages apply here as well.

Further advantages and preferred features and combinations of features are described herein and are shown in the figures.

To that end, the present invention is explained in more detail below in light of the figures.

### BRIEF DESCRIPTION OF THE DRAWINGS

FIG. 1 shows a simplified top view of a motor vehicle.

FIG. 2 shows a flow chart for explaining an advantageous method of operating the motor vehicle.

### DETAILED DESCRIPTION OF EXAMPLE EMBODIMENTS

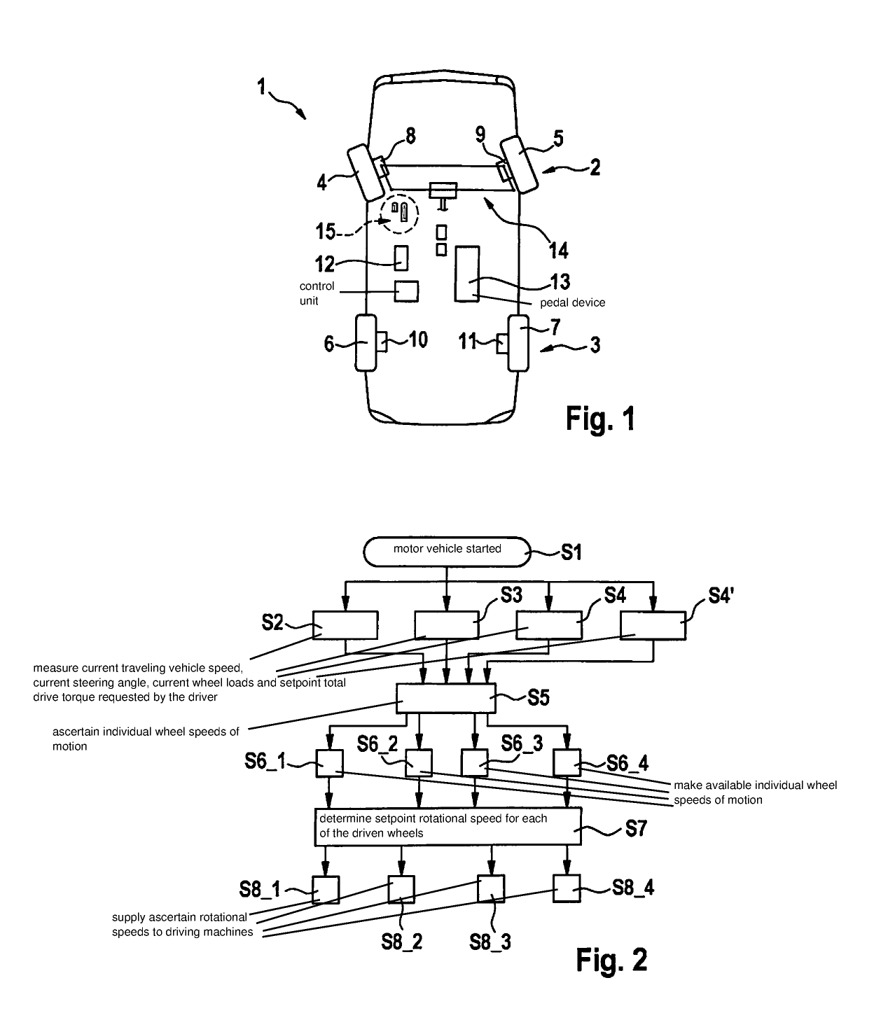

FIG. 1 shows a simplified top view of a motor vehicle 1, which includes a front wheel axle 2 and a rear wheel axle 3. The two wheel axles 2, 3 each include two driven wheels 4, 5 and 6, 7, respectively. In this context, each of driven wheels 4 through 7 is assigned a driving machine 8, 9, 10, 11, which, in each instance, takes the form of an electrical machine. In this context, driving machines 8 through 11 take the form of driving machines close to the rim, in particular, wheel-hub driving machines, which may transmit, directly or via a transmission gear, a positive or negative drive torque to associated driven wheels 4 through 7, respectively. To control driving machines 8 through 11, a control unit 12, which is connected to driving machines 8 through 11 via signals, is provided. In addition, driving machines 8 through 11 are each connected to an electrical energy store 13 by power electronics of control unit 12, the electrical energy store providing driving machines 8 through 11 with electrical energy for motive operation, or absorbing electrical energy in a regenerative operation of driving machines 8 through 11. In addition, at least one of wheel axles 2, 3, in this case, front wheel axle 2, is assigned a steering device 14, by which a steering angle at driven wheels 4, 5 may be set.

Control unit 12 controls driving machines 8 through 11 as a function of a requested setpoint total drive torque, which may be selected, for example, by a driver of motor vehicle 1 by manipulating a pedal device 15; which means that the driving machines jointly apply a drive torque to motor vehicle 1.

Due to individual-wheel electric drive, rapid regulation and selective control of the individual driven wheels is rendered possible. In order to prevent one or more of the driven wheels from spinning, the example method for operating motor vehicle 1 is implemented; the method being clarified in more detail in FIG. 2 and being executed, in particular, by control unit 12.

In this context, FIG. 2 shows a flow chart, with the aid of which the advantageous method is described. In a first step S1, motor vehicle 1 is started. Subsequently, a current vehicle traveling speed, a current steering angle of steering device 14, optionally, current wheel loads of all driven wheels 4 through 7, and the setpoint total drive torque requested by the driver, are measured in steps S2, S3, S4′, and S4, respectively. Steps S2, S3, S4 and S4′ are executed either in succession or, preferably, simultaneously. To determine the wheel loads, the spring travels of the chassis at the individual wheels and/or the present tire pressure of the specific wheel is measured and evaluated.

In a subsequent step S5, individual wheel speeds of motion are ascertained as a function of the current vehicle traveling speed, the steering angle, the wheel loads, and the known chassis geometry of the chassis of motor vehicle 1; and in a step S6_1, S6_2, S6_3 and S6_4, the individual wheel speeds of motion for each of driven wheels 4 through 7 are made available. The chassis geometry is derived, in particular, from the set-up of driven wheels 4 through 7, as well as from its change due to different wheel loads and/or due to an action of steering device 14. Since the geometric interrelationships are known from the construction of motor vehicle 1, these may be taken into account by control unit 12 in a simple manner, in order to determine an accurate, individual wheel speed of motion on a roadway not shown in the figure.

In a following step S7, setpoint rotational speeds are determined for each of the driven wheels, as a function of the individual wheel speeds of motion, in such a manner, that a slip of the specific wheel on the roadway is prevented at the respective setpoint rotational speed. The ascertained setpoint rotational speeds are then supplied to the driving machines in steps S8_1 through S8_4. Since the chassis and steering geometries of the motor vehicle are known and may be modeled by the control unit, using software/an algorithm, the absolute path of each driven wheel above ground or over the roadway, and the path relative to the other driven wheels, may be determined absolutely at any time, even during cornering and when traveling over uneven terrain. Since the wheel load distribution of all wheels is known due to the spring travel sensory system or other sensor system, the total drive torque (or braking torque) is distributed to driven wheels 4 through 7 as a function of these wheel loads. The spring travel has an effect on the distance to cover or distance covered of the specific driven wheel; the wheel load has an effect on the torque transmittable at the wheel. Spring travel and wheel load may be back-calculated, for example, using the measured tire pressure. The ground composition and, therefore, also the adhesion coefficient, may be deduced with the aid of the suitable sensory system (or, alternatively, set manually), and therefore, the total drive torque may be limited. In view of the geometry, combined with the rotational speed regulation via the driving machines 8 through 11 of the individual wheels, an individual driven wheel 4 through 7 is prevented from spinning on the roadway and, e.g., damaging the ground surface, due to little contact with the ground. Due to the lower adhesion, this driven wheel transmits less torque to the ground; however, it does not spin, since the vehicle continues to move at the same speed due to the traction present at the remaining driven wheels, and consequently, it does not damage the ground. In the case of reaching the limited total drive torque prior to achieving the driver's wish, the vehicle becomes slower or simply stops, but the ground surface is not damaged.

In contrast to conventional design approaches in motor vehicles, a further advantage is that this function works solely on the basis of rotational speed information in the driving machines 8 through 11 of the individual wheels, even without friction brake devices and their wheel speed measurement and/or monitoring.

The method described may also be applied to an axial-specific drive, in which the combined speeds of wheel axles 2, 3 are known due to the known chassis and steering geometries. Consequently, front wheel axle 2 and rear wheel axle 3 may be synchronized, which is equivalent to the function of a center differential lock while driving straight ahead. During cornering, the electronic coupling has the advantage, that the compensation for the different path lengths of front wheel axle 2 and rear wheel axle 3 by adjustment of the rotational speeds, prevents the otherwise forcibly occurring slip at at least one driven wheel 4 through 7.

In an advantageous manner, the method additionally provides for a loss of adhesion of all driven wheels 4 through 7 to be detected, by comparing, in particular, measurements of the traveling speed, acceleration and/or yaw rate of motor vehicle 1 independent of the wheel speed, to the wheel rotational speeds or setpoint rotational speeds of driven wheels 4 through 7. Alternatively, it is provided that the method be executed only if the motor vehicle is moving at vehicle traveling speeds less than a specifiable limiting value, possibly aided by a limitation of power output as a function of the composition of the roadway, on which motor vehicle 1 moves along. In this manner, the adhesion limit of a plurality of, in particular, all of driven wheels 4 through 7 is reliably prevented from being exceeded. In this context, the limitation of power output is preferably carried out as a function of an adhesion coefficient for previously known roadway compositions, such as asphalt, grass, fine gravel, crushed rock, or the like; the limitation of power output being manually selectable or automatically adjustable/measurable, using appropriate sensor technology.

In order to keep the system simple, exclusively controlled functioning of the automatic speed control is provided as an alternative. However, since, in the controlled system, the accuracy of the control is a function of the measured parameters, and these are limited due to the desired simplicity of the system, the controlled operation may produce distortions in the drive system, for example, due to different tire pressures and/or tread depths of the driven wheels, which have an effect on the vehicle dynamics. In order to reduce these effects, the controlled operation is preferably implemented on roadways, which have a decreased adhesion coefficient, and on which the spinning of driven wheels 4 through 7 should be prevented, and the controlled operation is preferably implemented at speeds below the aforementioned limiting value.

The described method and/or system (both regulated and controlled) is advantageously used in motor vehicles having individual-wheel drive, on sensitive surfaces, in order to prevent the spinning of individual or all driven wheels and the accompanying damage to the ground surface, such as grass or forest soil.

What is claimed is:

1. A method for operating a motor vehicle, which includes a plurality of driven wheels and a plurality of driving machines, each of the driven wheels being assigned a respective driving machine of the driving machines, the driving machines being electrical machines, the method comprising:
determining a setpoint total drive torque;
measuring a current vehicle traveling speed, and current steering angle;
determining individual wheel speeds of motion of the driven wheels over the roadway as a function of the current vehicle traveling speed, the current steering angle, and a known chassis geometry of the motor vehicle;
determining a respective setpoint rotational speed for each of the driven wheels as a function of the determined speeds of motion, and distributing the setpoint total drive torque to all of the driven wheels in such a manner, that spinning of the specific driven wheel on the roadway is prevented; and
controlling each of the driving machines to set the respective setpoint rotational speed at the respective driven wheel.

2. The method as recited in claim 1, wherein the measuring includes measuring wheel loads of all of the driving wheels, and wherein the determining of individual wheel speeds of motion of the driven wheels is also as a function of the wheel loads.

3. The method as recited in claim 1, wherein from the speeds of motion of the driven wheels of a common wheel axle, a combined speed of the wheel axle is determined.

4. The method as recited in claim 1, wherein as a function of the determined combined speed of a plurality of wheel axles, the wheel axles are synchronized with regard to their rotational speed.

5. The method as recited in claim 1, wherein the vehicle traveling speed is ascertained as a function of at least one of: (i) at least one actual rotational speed, (ii) an acceleration, (iii) a yaw rate, (iv) data of a satellite-protected navigation system, and (v) data of a surround sensor system of the motor vehicle.

6. The method as recited in claim 1, wherein the method is executed only at speeds below a specifiable limiting value.

7. The method as recited in claim 1, wherein a current roadway composition is ascertained, and the method is executed as a function of the current roadway composition.

8. The method as recited in claim 1, wherein the setpoint rotational speeds are regulated or controlled.

9. A control unit for operating a motor vehicle, which includes a plurality of driven wheels and a plurality of driving machines, each of the driven wheels being assigned a respective one of the driving machines, the driving machines being electric machines, the control unit configured to:
determine a setpoint total drive torque;
measuring a current vehicle traveling speed, and a current steering angle;
determine individual wheel speeds of motion of the driven wheels over the roadway as a function of the current vehicle traveling speed, the current steering angle, and a known chassis geometry of the motor vehicle;
determine a respective setpoint rotational speed for each of the driven wheels as a function of the determined speeds of motion, and distribute the setpoint total drive torque to all of the driven wheels in such a manner, that spinning of the specific driven wheel on the roadway is prevented; and
control each of the driving machines to set the respective setpoint rotational speed at the respective driven wheel.

10. A motor vehicle having a plurality of driven wheels and a plurality of driving machines, each of the driven wheels being assigned a respective one of the driving machines, the driving machines being electrical machine, each of the driven wheels being assigned a respective one of the driving machines, the driving machines being electrical machines, the motor vehicle further comprising a control unit, the control unit configured to:
determine a setpoint total drive torque;
measuring a current vehicle traveling speed, a current steering angle;
determine individual wheel speeds of motion of the driven wheels over the roadway as a function of the current vehicle traveling speed, the current steering angle, a known chassis geometry of the motor vehicle;
determine a respective setpoint rotational speed for each of the driven wheels as a function of the determined speeds of motion, and distribute the setpoint total drive torque to all of the driven wheels in such a manner, that spinning of the specific driven wheel on the roadway is prevented; and
control each of the driving machines to set the respective setpoint rotational speed at the respective driven wheel.
